(19) United States
(12) Patent Application Publication
(10) Pub. No.: US 2003/0047246 A1
(43) Pub. Date: Mar. 13, 2003

(54) Material for tension type color-selective device for color cathode-ray tube and method of producing same

(75) Inventors: Ken Inoue, Yonago-shi (JP); Junichi Nishida, Yasugi-shi (JP)

Correspondence Address: SUGHRUE, MION, ZINN, MACPEAK & SEAS, 2100 Pennsylvania Avenue, N.W., Washington, DC, 20037-3202, US

(73) Assignee: HITACHI METALS, LTD.

(21) Appl. No.: 10/125,433

(22) Filed: Apr. 19, 2002

(30) Foreign Application Priority Data
Apr. 23, 2001 (JP) 2001-124546

(51) Int. Cl. C22C 38/12; C22C 38/00; C22C 38/22

(52) U.S. Cl. 148/320

(57) ABSTRACT

There are provided a material for a tension type color-selective device for a color cathode-ray tube, the material consisting essentially, by mass, of 0.1 to 1.0% Mo, from 0 but less than 0.01% W, from 0 but less than 0.2% Cr, less than 0.05% C, and the balance substantially Fe, the material having a half-width not less than 0.2 of a diffraction peak obtained regarding a (211) plane of the material in a X-ray diffraction by use of a Co-Kα₁ ray, and a method of producing the material.

### BACKGROUND OF THE INVENTION

The present invention relates to a material superior in a creep resistance characteristic which material is used for a tension-type color-selective device such as a shadow mask adopting a tension system and an aperture grille which color-selective device is mounted in a color cathode-ray tube.

In a case of, for example, a shadow mask provided with many apertures through which electron beams pass which shadow mask is used as a color-selective device used in a color cathode-ray tube, the press-working of a steel sheet is usually performed so that an image plane may be made to have a curvature (, which is called “a forming system”). However, as a demand for each of a large size design of the image plane of the cathode-ray tube, a flat design thereof and a high fineness design thereof increases, there comes to be broadly used such a tension type of shadow mask adopting another system (tension system) in which a large tensile stress is previously applied to the steel sheet.

Further, as the tension type color-selective device, there is an aperture grille in which many slits are formed in a steel sheet, which is also used in correspondence to each of the large size design of the image plane of the cathode-ray tube, the flat design thereof and the high fineness design thereof all demanded in recent years.

Since each of these color-selective devices is always exposed to the irradiation of electron beams during the operation of the cathode-ray tube, the temperature of the color-selective device itself rises up to about 100° C., so that there occurs a thermal expansion in the color-selective device. The thermal expansion causes the deformation of the electron beam-passing apertures or the slits formed in the color-selective device, due to which deformation occurs the mislanding of the electron beams which causes the deterioration of color purity of an image.

In order to prevent the phenomenon from occurring, there is broadly used, as the material of the color-selective device of the forming system, an invar alloy having a low thermal expansion coefficient which contains as the main constituents thereof 36 mass % Ni and the balance Fe, however, there is such a problem as the forming working and etching of the invar alloy are difficult together with the high cost thereof.

On the other hand, in the tension type color-selective device such as the shadow mask and the aperture grille both adopting the tension system, the device is maintained in a state where a tensile stress is applied to its steel sheet itself. Thus, even in a case where the shape of the color-selective device is warped due to the thermal expansion thereof, the device is made to have such a design as the tensile stress applied thereto compensates for the warp so that no misalignment of the electron beam-passing apertures may occurs, with the result that it is possible to use an inexpensive Al-killed steel as the material of the color-selective device.

In the production of the color cathode-ray tube in which the tension type color-selective device is mounted, there are used steps of welding-and-securing a steel sheet member, in which the electron beam passing apertures or slits are previously formed by an etching working, to a metal frame while applying a tensile stress to the steel sheet member, and then performing the blackening treatment thereof by use of a steam or gas so that a dense oxide coating having a good adhesion may be formed on the surface of a mask to thereby prevent any gas, secondary electrons, thermal radiation and rusts from occurring from the interior thereof, which blackening treatment is usually performed at a temperature of 450° C. to 500° C.

However, in the blackening treatment, since the steel sheet member (, that is, the color-selective device) is held at the high temperature in a state where the tensile stress is applied to the steel sheet member, there is such a problem as the creep deformation of the steel sheet member occurs with the result that the tensile stress applied thereto is lowered. In a case where the decrease in the tensile stress is large, the resonance of the color-selective device occurs due to the sounds of the speaker in the operation of the cathode-ray tube with the result that the deterioration of color purity occurs. Thus, in order to prevent the decrease in the tensile stress from occurring in the high temperature circumstance present in the blackening treatment, it is necessary to enhance the creep strength of the steel sheet member.

As means for achieving this enhancement are present a method in which N is added in the Al-killed low alloy steel so that a Cottrell atmosphere may occur to fix dislocations (JP-A-62-249339 and JP-A-11-222628), another method in which Mn and N is added to suppress the displacement of dislocations by use of the atomic pair of Mn and N (JP-A-05-311332), still another method in which both of Cr and Mo are added to obtain the solid solution strengthening brought about by the adding thereof (JP-A-02-174042), and another method in which both of W and Mo are added to obtain the solid solution strengthening and the precipitation hardening brought about by the carbides thereof (JP-A-08-27541).

### SUMMARY OF THE INVENTION

These methods are effective which are provided from the viewpoint of metallurgy, however, the creep strength obtained in each of the methods is not necessarily sufficient as the material for the tension type color-selective device relating to the field of the invention.

For example, although the Cottrell atmosphere provided by nitrogen improves the creep strength because of the fixing of the dislocations, the diffusion rate of nitrogen becomes large insofar as the atmosphere of the blackening treatment performed at 400° C. or more is concerned, so that it becomes impossible to obtain the sufficient effect thereof. As regards the case of the means in which the affinity of Mn and N is utilized, the creep strength is improved in a degree larger than that of the adding of nitrogen alone, however, the value of the improved creep strength is too insufficient to satisfy such a creep resistance characteristic as to be required in the tension type color-selective device.

Further, according to the research of the inventors of the invention, the affinity of chromium for carbon is so intensive that a carbide comes to occur which does not become a barrier effective to suppress the displacement of the dislocations. Also, tungsten is apt to combine with carbon to thereby cause carbides, so that tungsten is not effective to obtain the sufficient fixing of the dislocations, either.

The object of the invention is to provide a material having a superior creep resistance characteristic which material is optimal for the tension type color-selective device such as a shadow mask and an aperture grille in each of which a tension system is adopted, and to provide a method of producing the material.

After detailed researches for solving the problem explained above, the inventors of the invention have found that the adding of Mo is very effective to improve the creep resistance characteristic, that is, the inventors have found that Mo has such a particular function as to have a moderate affinity for interstitial atoms such as carbon and nitrogen, whereby the inventors have achieved the present invention.

According to the first aspect of the invention, there is provided a material for a tension type of color selective device for a color cathode-ray tube, consisting essentially, by mass, of 0.1 to 1.0% Mo (molybdenum), not less than 0 but less than 0.01% W (tungsten), not less than 0 but less than 0.2% Cr (chromium), less than 0.05% C (carbon), and the balance substantially Fe (iron), the material having a half-width not less than 0.2 of diffraction peak obtained regarding the (211) plane of the material in a X-ray diffraction by use of the Co-K al ray.

According to the second aspect of the invention, there is provided a material for a tension type of color selective device for a color cathode-ray tube, consisting essentially, by mass, of 0.1 to 1.0% Mo, not less than 0 but less than 0.01% W, not less than 0 but less than 0.2% Cr, less than 0.05% C, and the balance Fe and other elements not more than 1.0% in total, the material having a half-width not less than 0.2 of diffraction peak obtained regarding the (211) plane of the material in a X-ray diffraction by use of the Co-Kα₁ ray.

In the material, the content of Mo is preferred to be in the range of 0.2 to 0.6 mass %, and the amount of N (nitrogen) is preferably in the range not more than 0.02 mass %.

According to the third aspect of the invention, there is provided a method of producing a material for a tension type of color selective device for a color cathode-ray tube, comprising the steps of preparing a material having a composition according to any one of the first and second aspects of the invention, and performing at least one time a cold rolling of and an annealing of the material, the final cold rolling of the cold rolling being performed with a rolling reduction not less than 30%, the final annealing subsequent to the final cold rolling being performed in a condition in which no re-crystallization occurs.

According to the fourth aspect of the invention, there is provided a method of producing a material for a tension type of color selective device for a color cathode-ray tube, comprising the steps of preparing a material having a composition according to any one of the first and second aspects of the invention, and performing at least one time a cold rolling of and an annealing of the material, the final cold rolling of the cold rolling being performed with a rolling reduction not less than 30%, the final annealing subsequent to the final cold rolling being performed at a temperature not more than 700° C.

In each of the methods according to the third and fourth aspects of the invention, a finishing rolling may be preformed at a rolling reduction not more than 7% after both of the final cold rolling and the final annealing subsequent thereto.

### DESCRIPTION OF THE PREFERRED EMBODIMENTS

Premising that an optimal strain is applied to the material for the tension type color-selective device, the most important features of the invention reside in the respects that the adding of Mo of a proper amount is found to be effective for bringing about the particular effect thereof while taking the interrelation between Mo and C into consideration, that the adding of each of Cr and W of appropriate amounts is effective for keeping the particular effect of Mo, and that an optimal method for producing the material is found. The details of the invention are described below.

First, the inventors of the invention have researched conditions required to obtain a superior creep strength regarding the material for the tension type color-selective device, and have found that means of applying a moderate working strain to the material can be successfully adopted. Specifically, in the state of the steel sheet material itself which is to be tensioned, the density of the dislocations existing in the steel sheet is made to be large and is optimized, and the degree thereof can be detected through the half-width of the peak in the X-ray diffraction with respect to the (211) plane of α-Fe.

In the case of the material according to the invention, the half-width of the diffraction peak regarding the (211) plane which diffraction peak is measured through the Co-Kα₁ ray is made to be not less than 0.2. In a case where the value of this half-width is too large, a magnetic permeability required in addition to the creep resistance characteristic becomes low. Thus, the half-width measured in the condition described above is preferably limited to be not more than 0.45.

In the invention, the effect of suppressing, after holding the tension type color-selective device, the deterioration of color purity is brought about by applying, in addition to the step of applying the tension to the steel sheet, the above-disclosed moderate working strain to the steel sheet material itself before the steel sheet is subjected to an etching treatment for producing the color-selective device. For example, as means for applying the moderate strain, the rolling-and-annealing conditions adopted to produce the steel sheet material may be optimized, which optimal conditions are described later.

However, regarding the optimal strain applied to the steel sheet material, the strain becomes meaningless in a case where the strain is gradually relieved during a high temperature treatment such as the blackening treatment. The inventors of the invention have researched means for maintaining the strain even at the high temperature and have found that the relieving of the strain can be suppressed by optimally selecting the composition of the steel sheet material. The chemical composition of the steel sheet material embodying the invention is described below.

In the invention, Mo is the most important element, which Mo is dissolved to strengthen the material to thereby enhance the yield strength and tensile strength thereof. Further, Mo has a small diffusion-coefficient in Fe and has in the dissolved state thereof an intensive affinity for the interstitial type of dissolved atoms such as carbon and nitrogen, so that Mo brings about such an effect as to make the creep deformation of the steel material remarkably small. This effect of Mo can be effectively used because Mo hardly causes carbides in distinction from W and Cr, which Mo is an element most effective to fix the dislocations.

The effect of the adding of Mo increases as the amount thereof is raised, however, in the invention it is intended to improve the creep resistance characteristic in a high temperature range such as 450 to 500° C. which creep resistance is required in the material for the tension type color-selective device. Thus, in the invention, it is indispensable that Mo be added by an amount not less than 0.1% which amount brings about the sufficient improvement of the creep strength of the material, and the amount of the added Mo is preferably in the range not less than 0.2%. However, in a case where Mo is added by an amount exceeding 1.0%, molybdenum carbides comes to occur with the results that the effect of fixing the dislocations decreases and that the etching ability thereof is deteriorated which is important when the material is used as that of a shadow mask or an aperture grille. As regards the creep resistance required in the field of the invention, it is sufficiently obtained by adding Mo up to 0.6%, and the adding of Mo exceeding 0.6% causes the rise of the production cost of the material. Thus, the content of Mo is limited to be in the range of 0.1 to 1.0% and preferably to be in the range of 0.2 to 0.6%.

C gathers around the dislocations to thereby provide the Cottrell atmosphere, so that it raises the strength of the steel sheet. This effect comes to be maintained even at the high temperature range only in a case where C coexists with Mo which is low in the capability of causing carbides in comparison with W and Cr and which has in the solid solution state thereof an intensive affinity for C. However, in a case where the content of C is not less than 0.05%, much amount of carbides come to occur with this effect of C decreasing, and the etchability of the steel sheet is deteriorated. Thus, in the invention, the amount is C is limited to be less than 0.05%, and the preferable amount of C for obtaining the above-explained effect is not less than 0.005%.

The atomic weight of W is about twice that of Mo, which W does not bring about so great effect regarding the enhancement of the creep strength of the steel sheet as Mo. Further, W is apt to cause the carbides in comparison with Mo, that is, much amount of carbides come to occur in the steel sheet in a case where the amount of W is not less than 0.01%, so that not only the amount of dissolved carbon effective to enhance the creep strength is decreased, but also the important etchability thereof is deteriorated. Thus, in the invention, the amount of W is limited to be less than 0.01% (0 inclusive), and preferably not more than 0.005% (0 inclusive).

Cr acts to accelerate the occurrence of a cementite. Thus, the excessive amount of Cr not only decreases the amount of the dissolved C effective to enhance the creep strength, but also deteriorates the important etchability, and in the invention the amount of Cr is limited to be less than 0.2% (0 inclusive) and preferably less than 0.15% (0 inclusive) and most preferably not more than 0.01% (0 inclusive).

Similarly to C, N gathers around the dislocations present in the steel sheet to thereby provide the Cottrell atmosphere, so that it raises the strength of the steel sheet. This effect of N comes to be maintained at the high temperature range only in the case where N coexists with Mo. However, in a case where the amount of N is more than 0.02%, much amount of molybdenum nitrides occurs which not only decreases this effect but also deteriorates the etchability of the steel sheet. Thus, in the invention, the amount of N is preferably not more than 0.02%.

In the steel sheet material of the invention for the tension type color-selective device, other elements may be contained, however, it is preferred that the total amount of these other elements except the balance Fe but including N be not more than 1.0%. Namely, at least one of Si, Mn, P, S, O and Al may be contained, however, the dissolving thereof, segregation or compounds caused by these elements deteriorate the etchability of the steel sheet material, and it is preferred that the amount of these elements existing as impurities be suppressed at a low level. Thus, in the invention, the amount of these elements including N is limited to be not more than 1.0% in total. Particularly, the individual amounts of Si, Mn, P, S, O and Al are preferably not more than 0.1%, not more than 0.5%, not more than 0.1%, not more than 0.1%, not more than 0.05% and not more than 0.1%, respectively.

On the other hand, as elements for raising the creep strength by adding a slight amount, there are Cu, B and Nb. In the invention, by adding at least one of these elements, it is possible to further improve the creep strength. Even in this case, the total amount of these elements and the above-described impurities elements is preferably limited to be not more than 1.0%.

By using the material having this chemical composition and the moderately regulated strain, it is possible to provide the material superior particularly in the creep resistance characteristic which material is used for the tension type color-selective device. Further, in the invention is provided the method of producing this material having the optimal strain state, which method is described below.

As described above, by properly regulating the amount of the strain, the material of the invention having the composition comes to have the superior creep resistance. In the material of the invention, by properly controlling not only the amount of the strain but also “the state of the strain”, it is possible to bring about the further improved creep strength. Namely, excessive dislocations are previously introduced in the material, and then this material is annealed in a proper condition, so that there occurs a strain state in which mobile dislocations disappear, which strain state is effective to improve the creep resistance.

Specifically, for example, as one preferred method of obtaining this strain state, there is a method of producing the steel sheet which method has the steps of performing the final cold rolling of the steel sheet material with a rolling reduction not less than 30%, and then performing the final annealing at a condition in which no re-crystallization occurs. By performing this final annealing, it is possible to thermally stabilize the dislocations, to thereby decrease the number of the mobile dislocations and to keep such a high level of magnetic permeability as to be required for the usage relating to the invention, and more specifically regarding the magnetic permeability, the maximum relative-permeability can be maintained at a level not less than 900 or not less than 1000 or not less than 1200. In this case, the conditions of the final annealing are set so that the material obtained by the cold working may not be substantially re-crystallized while taking each of the performance of a heating equipment, a production efficiency and the attainment of a low cost into consideration. For example, in the continuous annealing of the steel sheet material, it is possible, by making the pass speed of the steel sheet material large, to suppress the occurrence of the re-crystallization even at an elevated temperature.

In the case of the chemical composition and the final cold rolling reduction relating to the invention, it is preferred that the final annealing be performed at a temperature not more than 700° C., and it is also preferred that a time for the heating in this final annealing be set to be not less than 20 seconds. As more preferred production conditions, the final cold rolling reduction is 40 to 85%, the temperature of the annealing following the final cold rolling being 550 to 690° C., and from the viewpoint of maintaining the high magnetic permeability, it is preferred that the temperature of the annealing following the final cold rolling be not more than 680° C. and that the heating time be in a range of 30 seconds to 10 minutes. In the continuous annealing of the steel sheet, the time for the heating is controlled by regulating the pass speed thereof.

Alternatively, the amount of the strain described above in relation to the invention can be achieved by another method comprising the step of performing the final cold rolling with a rolling reduction not more than 60% without performing any final annealing. In this case, it is necessary to select the value of the rolling reduction while sufficiently taking into consideration the respect that the value of the magnetic permeability decreases due to the omission of the final annealing.

Further, in the final step of the production method, a finishing rolling may be performed in addition to the final cold rolling. As this finishing rolling, there is a dull rolling etc. for roughening the surface of the steel sheet so that the good adhesion of a resist may be kept which is used in an etching step, that is, the finishing rolling may be performed as occasion demands while taking into account the respects that the optimal amount and state of the strain must be maintained after the finishing rolling and that the high magnetic permeability must be maintained thereafter. Thus, in the case of performing the finishing rolling, the value of the rolling reduction may be selected from the range not more than 7%. Further, a tension leveler may be performed for the purpose of straightening the shape.

The embodiments according to the invention are described below.

First, there were prepared alloys having chemical compositions disclosed in Table 1, in which it was confirmed that, regarding each of the samples of the invention, the total amount of the “other” elements (other than Mo, W, Cr, C and Fe) including all of the representative elements (impurities) shown in Group “A” and elements (impurities) not shown in Table 1 was not more than 1.0%.

Each of these alloys was hot-rolled into a sheet material having a thickness of 2.5 mm. Regarding each of the sheet material were repeated the cold rolling and annealing, and the final cold rolling was performed with a rolling reduction of 50%, so that a steel sheet of 0.1 mm in thickness was produced. Then, the final annealing thereof was performed at 550° C. for a five minutes, so that each of the steel sheets of the embodiments was obtained. In the steel sheet corresponding to sample No. 3 was performed no final annealing, and the final annealing was performed at 800° C. for 2 minutes regarding each of steel sheets corresponding to samples Nos. 4 and 6. As regards the steel sheet corresponding to sample No. 17, the final annealing was performed at a high temperature of 690° C. with a heat treatment time of 30 seconds, that is, in such conditions as to be capable of suppressing the re-crystallization thereof. In the steel sheet corresponding to sample No. 18 was performed the finishing rolling with a rolling reduction of 4% in addition to the same steps as those of sample No. 17.

Regarding each of the steel sheets thus obtained, an X-ray diffraction test for measuring the strain occurring in the steel sheet was performed through Co-Kα₁ ray by use of apparatus “RINT 2500” manufactured by Rigaku Co, Ltd., in which a characteristic X-ray was generated with a tube voltage of 40 KV with a tube current of 200 mA through a Co target, and the half-width of the diffraction peak obtained thereby regarding the (211) crystal plane was measured, the results thereof being shown in Table 1.

TABLE 1
(mass %, the balance Fe)

| | | | | | Group A | | | | | | | Group A | (211) | |
|---|---|---|---|---|---|---|---|---|---|---|---|---|---|---|
| No. | Mo | W | Cr | C | Si | Mn | P | S | Al | O | N | Total | The half-width | Remark |
| 1 | 0.12 | 0.004 | 0.009 | 0.0095 | 0.002 | 0.29 | 0.005 | 0.0029 | 0.009 | 0.007 | 0.0006 | 0.3165 | 0.30 | the invention |
| 2 | 0.29 | 0.002 | 0.007 | 0.0126 | 0.002 | 0.26 | 0.020 | 0.0042 | 0.006 | 0.101 | 0.0005 | 0.3027 | 0.35 | ″ |
| 3 | ″ | ″ | ″ | ″ | ″ | ″ | ″ | ″ | ″ | ″ | ″ | ″ | 0.47 | ″ |
| 4 | ″ | ″ | ″ | ″ | ″ | ″ | ″ | ″ | ″ | ″ | ″ | ″ | 0.14 | comparative sample |
| 5 | 0.88 | 0.002 | 0.004 | 0.0315 | 0.009 | 0.30 | 0.019 | 0.0045 | 0.002 | 0.009 | 0.0004 | 0.3439 | 0.39 | the invention |
| 6 | ″ | ″ | ″ | ″ | ″ | ″ | ″ | ″ | ″ | ″ | ″ | ″ | 0.12 | comparative sample |
| 7 | 0.89 | 0.005 | 0.007 | 0.0093 | 0.007 | 0.27 | 0.019 | 0.0061 | 0.001 | 0.009 | 0.0150 | 0.3271 | 0.30 | the invention |
| 8 | 0.21 | 0.003 | 0.007 | 0.0104 | 0.015 | 0.28 | 0.020 | 0.0045 | 0.004 | 0.010 | 0.0118 | 0.3453 | 0.28 | ″ |
| 9 | 0.59 | 0.002 | 0.003 | 0.0107 | 0.007 | 0.30 | 0.020 | 0.0042 | 0.005 | 0.017 | 0.0066 | 0.3598 | 0.22 | ″ |
| 10 | 0.33 | 0.001 | 0.120 | 0.0110 | 0.012 | 0.30 | 0.018 | 0.0040 | 0.004 | 0.011 | 0.0007 | 0.3497 | 0.29 | ″ |
| 11 | 0.05 | <0.001 | 0.001 | 0.0087 | 0.001 | 0.29 | 0.005 | 0.0031 | 0.008 | 0.004 | 0.0007 | 0.3118 | 0.29 | comparative sample |
| 12 | 0.04 | 0.008 | 0.050 | 0.0410 | 0.012 | 0.25 | 0.022 | 0.0090 | 0.001 | 0.012 | 0.0045 | 0.3105 | 0.55 | ″ |
| 13 | 0.01 | 0.010 | 0.040 | 0.0078 | 0.003 | 0.42 | 0.019 | 0.0080 | 0.001 | 0.006 | 0.0105 | 0.4675 | 0.40 | ″ |
| 14 | 0.07 | 0.390 | 0.010 | 0.0058 | 0.010 | 0.30 | 0.016 | 0.0055 | 0.005 | 0.011 | 0.0020 | 0.3495 | 0.37 | ″ |
| 15 | 0.14 | 0.490 | 0.011 | 0.0062 | 0.006 | 0.31 | 0.022 | 0.0050 | 0.005 | 0.012 | 0.0016 | 0.3616 | 0.35 | ″ |
| 16 | 0.11 | 0.003 | 0.300 | 0.0322 | 0.012 | 0.29 | 0.020 | 0.0057 | 0.005 | 0.004 | 0.0008 | 0.3318 | 0.35 | ″ |
| 17 | 0.29 | 0.009 | 0.010 | 0.0090 | 0.010 | 0.30 | 0.006 | 0.0010 | 0.002 | 0.007 | 0.0019 | 0.3279 | 0.30 | the invention |
| 18 | ″ | ″ | ″ | ″ | ″ | ″ | ″ | ″ | ″ | ″ | ″ | ″ | 0.35 | ″ |

Then, from each of the thus produced steel sheets was prepared a test piece for a tensile test having a parallel portion of 30 mm in length, by use of which test piece was performed a constant load test in which a stress of 294 MPa was applied thereto at 460° C. for 60 minutes and in which a creep elongation occurring in this test was measured.

TABLE 2

| | | Maximum | |
|---|---|---|---|
| | Creep | relative | |
| No. | elongation (%) | permeability | Remark |
| 1 | 0.46 | 1400 | the invention |
| 2 | 0.10 | 1350 | ″ |
| 3 | 0.11 | 700 | ″ |
| 4 | Rupture | 3300 | comparative sample |
| 5 | 0.06 | 980 | the invention |
| 6 | Rupture | 3600 | comparative sample |
| 7 | 0.04 | 1010 | the invention |
| 8 | 0.08 | 1370 | ″ |
| 9 | 0.10 | 1370 | ″ |
| 10 | 0.30 | 1200 | ″ |
| 11 | 0.89 | 1400 | comparative sample |
| 12 | 5.06 | 1120 | ″ |
| 13 | 0.56 | 1310 | ″ |
| 14 | 0.70 | 1380 | ″ |
| 15 | 0.57 | 1360 | ″ |
| 16 | 0.64 | 1400 | ″ |
| 17 | 0.12 | 1730 | the invention |
| 18 | 0.10 | 1680 | ″ |

As apparent from Table 2, the creep elongation of each of samples Nos. 1 and 2 is lower than that of the comparative sample. Sample No. 3 in which no final annealing was performed has also a low creep elongation although the magnetic permeability thereof decreases. In each of samples Nos. 5, 7 and 8 in which the amount of C or N is raised while taking caution against the occurrence of carbides and/or nitrides and in which the effect of the affinity for Mo is increased, the amount of the creep elongation is suppressed to be a further low level.

In sample No. 9, although the amount of the strain is made to be in a low level, the low value of creep elongation is achieved because N is made to coexist by an amount matching with the amount of Mo. In sample No. 10, since the amount of Mo is regulated to be in a preferred range although the amount of Cr is somewhat high, the low value of creep elongation is achieved. In sample No. 17, since the heat treatment was performed in the condition where no re-crystallization occurred in spite of the high final annealing temperature, both of the low value of creep elongation and the high magnetic permeability are obtained. In sample No. 18, the magnetic permeability somewhat decreases in comparison with that of sample No. 17 due to the influence of the finishing rolling, however, the value of the creep elongation is suppressed to be at a low level.

On the other hand, although each of samples Nos. 4 and 6 has the same composition as that of each of samples Nos. 2 and 5 to thereby satisfy the range of the chemical composition limited in the invention, the amount of the strain itself provided in the material was low, and the material was broken during the test. In sample No. 11, the value of the creep elongation is large due to the low amount of Mo, the similar unfavorable result occurs in each of samples Nos. 12 and 13 due to the much amount of C or N. Further, in each of samples Nos. 14 and 15 in which the much amount of W is contained and in sample No. 16 in which the much amount of Cr is contained, it is impossible to obtain a sufficient level of creep elongation.

In the invention is produced the material superior in creep resistance characteristic even in an atmosphere not less than 400° C., which makes it possible to provide an optimal material for the tension type color-selective device such as the shadow mask and the aperture grille in which the tension system is adopted. Further, the production method of the invention is effective to produce a material for the tension type color-selective device superior in creep resistance characteristic. Thus, the invention is of industrial value.

What is claimed is:

1. A material for a tension type color-selective device for a color cathode-ray tube, said material consisting essentially, by mass, of 0.1 to 1.0% Mo, not less than 0 but less than 0.01% W, not less than 0 but less than 0.2% Cr, less than 0.05% C, and the balance substantially Fe, said material having a half-width not less than 0.2 of a diffraction peak obtained regarding a (211) plane of said material in a X-ray diffraction by use of a Co-Kα₁ ray.

2. A material for a tension type color-selective device for a color cathode-ray tube, said material consisting essentially, by mass, of 0.1 to 1.0% Mo, not less than 0 but less than 0.01% W, not less than 0 but less than 0.2% Cr, less than 0.05% C, and the balance Fe and other elements not more than 1.0% in total, said material having a half-width not less than 0.2 of a diffraction peak obtained regarding a (211) plane of said material in a X-ray diffraction by use of a Co-Kα₁ ray.

3. A material for a tension type color-selective device for a color cathode-ray tube according to claim 1, wherein the content of Mo is 0.2 to 0.6 mass %.

4. A material for a tension type color-selective device for a color cathode-ray tube according to claim 2, wherein the content of Mo is 0.2 to 0.6 mass %.

5. A material for a tension type color-selective device for a color cathode-ray tube according to claim 1, wherein the content of N is not more than 0.02 mass %.

6. A material for a tension type color-selective device for a color cathode-ray tube according to claim 2, wherein the content of N is not more than 0.02 mass %.

7. A material for a tension type color-selective device for a color cathode-ray tube according to claim 3, wherein the content of N is not more than 0.02 mass %.

8. A material for a tension type color-selective device for a color cathode-ray tube according to claim 4, wherein the content of N is not more than 0.02 mass %.

9. A method of producing a material for a tension type color-selective device for a color cathode-ray tube, comprising the steps of:
preparing an alloy having a composition according to claim 1; and
performing at least one time each of a cold rolling and an annealing regarding said alloy,
said cold rolling including a final cold rolling performed with a rolling reduction not less than 30%,
said annealing including an annealing subsequent to said final cold rolling being performed in a condition in which no re-crystallization occurs.

10. A method of producing a material for a tension type color-selective device for a color cathode-ray tube, comprising the steps of:
preparing an alloy having a composition according to claim 2; and
performing at least one time each of a cold rolling and an annealing regarding said alloy,
said cold rolling including a final cold rolling performed with a rolling reduction not less than 30%,
said annealing including an annealing subsequent to said final cold rolling being performed in a condition in which no re-crystallization occurs.

11. A method of producing a material for a tension type color-selective device for a color cathode-ray tube, comprising the steps of:
preparing an alloy having a composition according to claim 7; and
performing at least one time each of a cold rolling and an annealing regarding said alloy,
said cold rolling including a final cold rolling performed with a rolling reduction not less than 30%,
said annealing including an annealing subsequent to said final cold rolling being performed in a condition in which no re-crystallization occurs.

12. A method of producing a material for a tension type color-selective device for a color cathode-ray tube, comprising the steps of:
preparing an alloy having a composition according to claim 8; and
performing at least one time each of a cold rolling and an annealing regarding said alloy,
said cold rolling including a final cold rolling performed with a rolling reduction not less than 30%,
said annealing including an annealing subsequent to the final cold rolling being performed in a condition in which no re-crystallization occurs.

13. A method of producing a material for a tension type color-selective device for a color cathode-ray tube, comprising the steps of:
preparing an alloy having a composition according to claim 1; and
performing at least one time each of a cold rolling and an annealing regarding said alloy,
said cold rolling including a final cold rolling performed with a rolling reduction not less than 30%,
said annealing including an annealing subsequent to said final cold rolling being performed at a temperature not more than 700° C.

14. A method of producing a material for a tension type color-selective device for a color cathode-ray tube, comprising the steps of:
preparing an alloy having a composition according to claim 2; and
performing at least one time each of a cold rolling and an annealing regarding said alloy,
said cold rolling including a final cold rolling performed with a rolling reduction not less than 30%,
said annealing including an annealing subsequent to said final cold rolling being performed at a temperature not more than 700° C.

15. A method of producing a material for a tension type color-selective device for a color cathode-ray tube, comprising the steps of:
preparing an alloy having a composition according to claim 7; and
performing at least one time each of a cold rolling and an annealing regarding said alloy,
said cold rolling including a final cold rolling performed with a rolling reduction not less than 30%,
said annealing including an annealing subsequent to said final cold rolling being performed at a temperature not more than 700° C.

16. A method of producing a material for a tension type color-selective device for a color cathode-ray tube, comprising the steps of:
preparing an alloy having a composition according to claim 8; and
performing at least one time each of a cold rolling and an annealing regarding said alloy,
said cold rolling including a final cold rolling performed with a rolling reduction not less than 30%,
said annealing including an annealing subsequent to said final cold rolling being performed at a temperature not more than 700° C.

17. A method of producing a material for a tension type color-selective device for a color cathode-ray tube according to claim 9, further comprising the step of performing, successively after said annealing following the final cold rolling, a finishing rolling with a rolling reduction not more than 7%.

18. A method of producing a material for a tension type color-selective device for a color cathode-ray tube according to claim 10, further comprising the step of performing, successively after said annealing following the final cold rolling, a finishing rolling with a rolling reduction not more than 7%.

19. A method of producing a material for a tension type color-selective device for a color cathode-ray tube according to claim 13, further comprising the step of performing, successively after said annealing following the final cold rolling, a finishing rolling with a rolling reduction not more than 7%.

20. A method of producing a material for a tension type color-selective device for a color cathode-ray tube according to claim 14, further comprising the step of performing, successively after said annealing following the final cold rolling, a finishing rolling with a rolling reduction not more than 7%.
